(19) United States
(12) Patent Application Publication
(10) Pub. No.: US 2010/0244742 A1
(43) Pub. Date: Sep. 30, 2010

(54) VARIABLE COLOR DISCHARGE LAMP

(75) Inventor: Te-Wen KUO, Hsinchu (TW)

Correspondence Address: RABIN & Berdo, PC, 1101 14TH STREET, NW, SUITE 500, WASHINGTON, DC, 20005, US

(73) Assignee: LITE-ON IT CORPORATION, Hsinchu (TW)

(21) Appl. No.: 12/543,728

(22) Filed: Aug. 19, 2009

(30) Foreign Application Priority Data
Mar. 31, 2009 (CN) 200910127998.0

(51) Int. Cl. H05B 41/36

(52) U.S. Cl. 315/307

(57) ABSTRACT

A variable color discharge lamp including a first lamp tube, a second lamp tube and a variable voltage system is provided. The first lamp tube having a first diameter has a first fluorescent powder disposed therein. The second lamp tube connected to the first lamp tube has a second diameter not equal to the first diameter. The second lamp tube has a second fluorescent powder disposed therein, wherein the second color temperature of the second fluorescent powder is not equal to the first color temperature of the first fluorescent powder. The variable voltage system provides and adjusts a common voltage of the first lamp tube and the second lamp tube. When the common voltage is adjusted, respective luminescence efficiencies of the first fluorescent powder and the second fluorescent powder vary with the common voltage, so as to adjust the mixed light color of the first and the second lamp tubes.

This application claims the benefit of People's Republic of China application Serial No. 200910127998.0, filed Mar. 31, 2009, the subject matter of which is incorporated herein by reference.

### BACKGROUND OF THE INVENTION

1. Field of the Invention

The invention relates in general to a discharge lamp, and more particularly to a variable color discharge lamp.

2. Description of the Related Art

In daily life, there are a number of indispensable lamp sources such as incandescent lamp, fluorescent lamp, high pressure gas discharge lamp and so forth. Compared with the incandescent lamp that has very poor photoelectrical conversion efficiency (only about 10% of the electricity is converted to the light) and generates high temperature, the fluorescent lamp has much higher photoelectrical conversion efficiency (near 40%) and generates only one sixth of the heat generated by the incandescent lamp of the same luminance, therefore the fluorescent lamp has been used for replacing the incandescent lamp to save power consumption in many places where air conditioning is needed such as office buildings, shopping malls and super markets. The small-sized fluorescent lamp (also called energy saving bulb), which combines the fluorescent lamp and the activating electronic element and adopts the same interface of standard bulb, can replace the regular incandescent lamp.

Most of the lamp sources used for illumination only provide one single color light, and the commonest color light being provided is the white light. Normally, extra control elements are needed for fabricating a lamp source whose color light is controllable or providing another color light. Conventionally, the variable color discharge lamp employs at least three adjusting systems for changing the intensity of the rare-gas discharge lamps of the red/green/blue lights respectively, so that the structure of the lamp source is made even more complicated and incurs more manufacturing costs.

### SUMMARY OF THE INVENTION

The invention is directed to a variable color discharge lamp. By changing the voltage, the luminescence efficiencies of the fluorescent powders disposed in the lamp tubes with different diameters vary so as to generate different light colors. Thus, the mixed light of the discharge lamp can switch among different light colors to meet the market demand without using any complicated structure.

According to a first aspect of the present invention, a variable color discharge lamp including a first lamp tube, a second lamp tube and a variable voltage system is provided. The first lamp tube with a first diameter has a first fluorescent powder disposed therein. The second lamp tube connected to the first lamp tube has a second diameter not equal to the first diameter. The second lamp tube has a second fluorescent powder disposed therein, wherein the second color temperature of the second fluorescent powder is not equal to the first color temperature of the first fluorescent powder. The variable voltage system provides and adjusts a common voltage of the first lamp tube and the second lamp tube. When the common voltage is adjusted, respective luminescence efficiencies of the first fluorescent powder and the second fluorescent powder vary with the common voltage, so as to adjust the mixed light color of the first lamp tube and the second lamp tube.

The invention will become apparent from the following detailed description of the preferred but non-limiting embodiments. The following description is made with reference to the accompanying drawings.

### BRIEF DESCRIPTION OF THE DRAWINGS

FIG. 1 shows a variable color discharge lamp according to a preferred embodiment of the invention;

FIG. 2 shows a luminescence efficiency relationship chart of the lamp tubes with different diameters under different voltages;

FIG. 3 shows an adjustable color changing region; and

FIG. 4 shows a lamp with spiral tube according to an embodiment of the invention.

### DETAILED DESCRIPTION OF THE INVENTION

The variable color discharge lamp disclosed in the embodiments of the invention includes at least two lamp tubes being connected together. The lamp tubes have different diameters, and the fluorescent powders disposed in the lamp tubes have different color temperatures. Due to the different diameters and the different fluorescent powders, the luminescence efficiencies of the fluorescent powders in the lamp tubes are affected by the voltage level so as to generate various mixed light colors. The multiple structures exemplified below are for elaboration only, not for limiting the scope of protection of the invention.

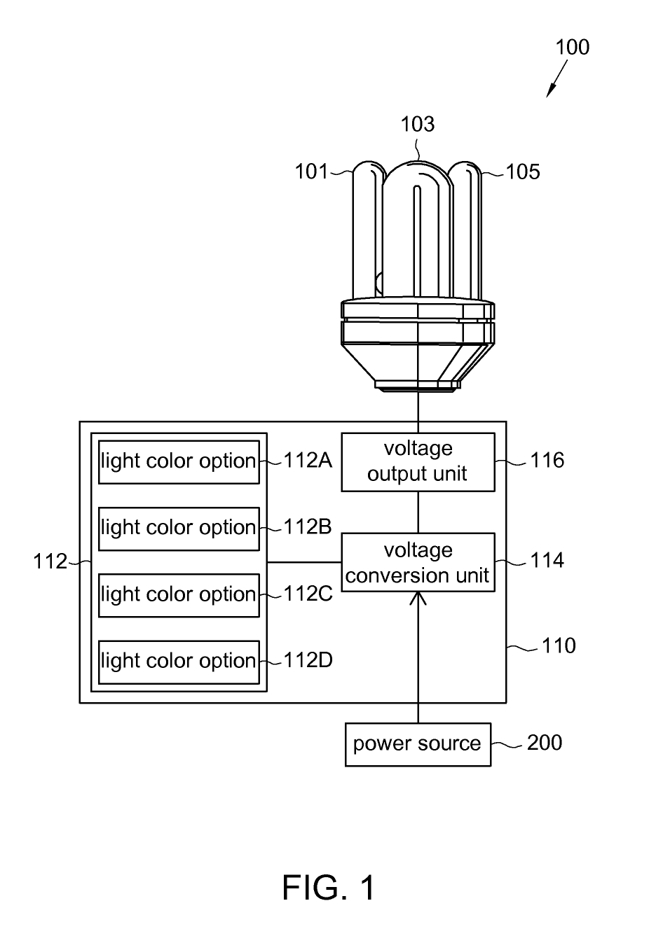

Referring to FIG. 1, a variable color discharge lamp according to a preferred embodiment of the invention is shown. The variable color discharge lamp 100 includes a first lamp tube 101, a second lamp tube 103, a third lamp tube 105 and a variable voltage system 110, wherein the first lamp tube 101, the second lamp tube 103 and the third lamp tube 105 are connected together so that the tubes are interconnected to form a single lamp tube, which are connected to the variable voltage system 110. The first lamp tube 101 has a first diameter, the second lamp tube 103 has a second diameter, and the third lamp tube 105 has a third diameter, wherein the first diameter, the second diameter and the third diameter are different. Besides, the first lamp tube 101, the second lamp tube 103 and the third lamp tube 105 are fluorescent lamp tubes for example. The first lamp tube 101 has a first fluorescent powder disposed therein, the second lamp tube 103 has a second fluorescent powder disposed therein, and the third lamp tube 105 has a third fluorescent powder disposed therein, wherein the color temperatures of the first fluorescent powder, the second fluorescent powder and the third fluorescent powder are different.

The single lamp tube formed by the first lamp tube 101, the second lamp tube 103 and the third lamp tube 105 is filled with low pressure argon or a mixed gas of argon and neon, and mercury vapor in addition to the fluorescent powders. The two ends of the single lamp tube have filament coils (or electrodes) for example. After the power source is conducted, the filament is heated by the current flowing through and releases electrons which converts the gas inside the lamp tubes to plasma and boosts the current in the lamp tubes. After the voltage between two sets of filaments exceeds a predetermined value, the fluorescent lamp tubes start to discharge, and the mercury vapor emits ultraviolet (UV) light next. After the fluorescent powders disposed in the fluorescent lamp tube are excited by UV light, a visible light with mixed color lights is emitted.

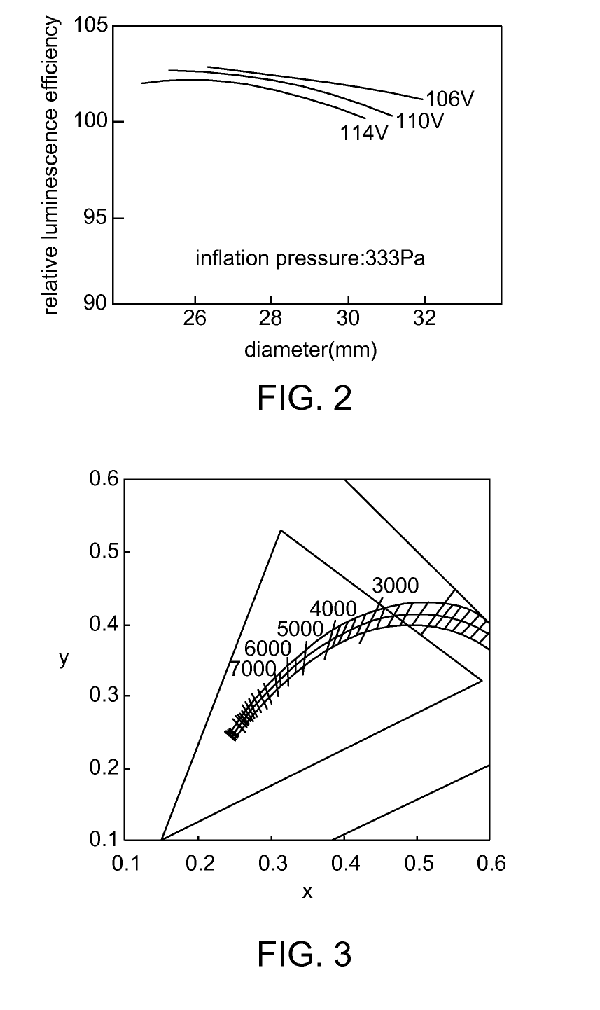

FIG. 2 shows a luminescence efficiency relationship chart of the lamp tubes with different diameters under different voltages. As indicated in FIG. 2, no matter the voltage level is high or low, the larger the tube diameter, the lower the luminescence efficiency will be. FIG. 3 shows an adjustable color changing region. As indicated in FIG. 3, the curve in the middle is a blackbody radiation line, the top curve and the bottom curve are two reference lines, the line segments crossing the curves are iso-temperature lines, and all the dots on the same iso-temperature line has the same color temperature. The chromaticity coordinates x and y of the light excited by the fluorescent powders with different color temperatures are different, and a new chromaticity coordinate is obtained after the lights are mixed, so that different light colors are displayed. Let the voltage 114V be taken for example. Given the condition that the inflation pressure is 333 Pa, the luminescence efficiency corresponding to the diameter of 30 mm is smaller than the luminescence efficiency corresponding to the diameter of 26 mm. In other words, the smaller the tube diameter, the higher the luminescence efficiency will be. Besides, when the voltage is varied from 114V down to 106V, no matter what tube diameter, the corresponding luminescence efficiency of the lamp varies with the voltage at the same time. As indicated in FIG. 2, when the voltage becomes smaller, the corresponding luminescence efficiency of the lamp increases.

As indicated in FIG. 1, the variable voltage system 110 provides a common voltage to the first lamp tube 101, the second lamp tube 103 and the third lamp tube 105. As the diameters of the first lamp tube 101, the second lamp tube 103 and the third lamp tube 105 are different, and the color temperatures of the first fluorescent powder, the second fluorescent powder and the third fluorescent powder are different, under the common voltage, respective luminescence efficiencies of the first fluorescent powder, the second fluorescent powder and the third fluorescent powder are different. The variable voltage system 110 can adjust the common voltage. During the adjustment of the common voltage, respective luminescence efficiencies of the first fluorescent powder, the second fluorescent powder and the third fluorescent powder vary with the common voltage, so that the proportions of the color lights of the mixed light change accordingly and the mixed light color of the first lamp tube 101, the second lamp tube 103 and the third lamp tube 105 is changed.

The structure of the variable voltage system 110 is elaborated. The variable voltage system 110 includes an adjustment unit 112, a voltage conversion unit 114 and a voltage output unit 116. The voltage conversion unit 114 is connected to an external power source 200 which provides a voltage to the voltage conversion unit 114, and further converts the voltage to the common voltage for the three lamp tubes. The adjustment unit 112 is used for providing multiple light color options such as the light color options 112A to 112D for the user to select the light color displayed by the variable color discharge lamp 100. Each of the light color options 112A to 112D corresponds to a predetermined voltage. After one of the light color options (such as the light color option 112A) is selected, the voltage conversion unit 114, according to the light color option 112A being selected, converts the common voltage to the predetermined voltage corresponding to the light color option 112A. Afterwards, the voltage output unit 116 outputs the predetermined voltage to the first lamp tube 101, the second lamp tube 103 and the third lamp tube 105.

For example, as indicated in FIG. 1, the first lamp tube 101, the second lamp tube 103 and the third lamp tube 105 are all U-shaped tubes connected to form a compact fluorescent lamp (CFL), which is 3U type variable color discharge lamp. In terms of the specification of the tube diameter, the first lamp tube 101, the second lamp tube 103 and the third lamp tube 105 are T2 lamp tube (about 6 mm), T3 lamp tube (about 9 mm) and T4 lamp tube (about 12 mm) in order. Preferably, the fluorescent powder with higher color temperature is disposed in the lamp with smaller tube diameter, and the fluorescent powder with lower color temperature is disposed in the lamp with larger tube diameter. That is, the color temperature of the fluorescent powder disposed in the lamp tube with smaller diameter is preferably larger than the color temperature of the fluorescent powder disposed in the lamp tube with larger diameter. For example, the fluorescent powder with color temperature 12000K is coated in the T2 lamp tube, the fluorescent powder with color temperature 4000K is coated in the T3 lamp tube, and the fluorescent powder with color temperature 2500K is coated in the T4 lamp tube.

According to the results indicated in FIG. 2 and FIG. 3, under different voltages and different lamp tube diameters, respective luminescence efficiencies of the first fluorescent powder (such as the fluorescent powder with color temperature 12000K), the second fluorescent powder (such as the fluorescent powder with color temperature 4000K) and the third fluorescent powder (such as the fluorescent powder with color temperature 2500K) are different. After the common voltage is converted to a predetermined voltage, respective luminescence efficiencies of the first fluorescent powder, the second fluorescent powder and the third fluorescent powder are adjusted accordingly, so that the color of the mixed lights emitted from the first, the second and the third lamp tubes is adjusted to another color. Likewise, after other light color option such as the light color option 112B, 112C or 112D is selected, the color of the mixed lights is adjusted to a color corresponding to the light color options.

In the present embodiment of the invention, the variable color discharge lamp 100 is exemplified by a compact fluorescent lamp, but the invention is not limited thereto. The variable color discharge lamp 100 can also be a hot cathode fluorescent lamp (HCFL) or a cold cathode fluorescent lamp (CCFL).

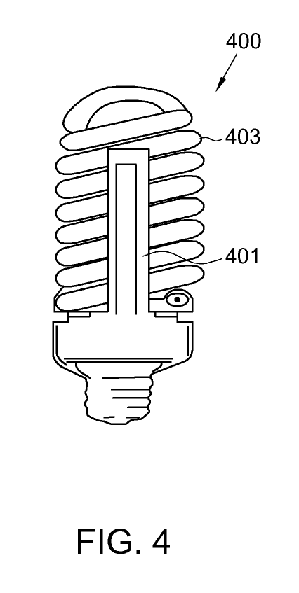

Moreover, the present embodiment of the invention does not limit to use three U-shaped tubes. Any structural designs of any number and any shapes of the lamp tubes incorporated with the fluorescent powders with different color temperatures are within the scope of protection of the invention. Referring to FIG. 4, a lamp with spiral tube according to an embodiment of the invention is shown.

As indicated in FIG. 4, the variable color discharge lamp 400 has two lamp tubes with different diameters. One of the lamp tubes is a U-shaped tube 401, and the other lamp tube is a spiral tube 403, wherein the U-shaped tube 401 and the spiral tube 403 are interconnected to form a single lamp tube so as to form a Tornado+U type variable color discharge lamp. The spiral tube 403, preferably but not limitedly, surrounds the U-shaped tube 401. In terms of the specification of the tube diameter, the U-shaped tube 401 is a T3 lamp tube for example, and the spiral tube 403 is a T4 lamp tube for example, wherein the fluorescent powder with color temperature 10000K is coated in the T3 lamp tube, and the fluorescent powder with color temperature 2500K is coated in the T4 lamp tube. Likewise, when the variable color discharge lamp 400 is incorporated with the variable voltage system 110 of FIG. 1, the mixed light color of the variable color discharge lamp 400 is adjustable, so that the mixed light of the variable color discharge lamp 400 can switch between different colors.

According to the variable color discharge lamp of the above embodiments of the invention, the discharge lamp has lamp tubes with different diameters, and the fluorescent powders with different color temperatures are disposed in the lamp tubes. The lamp tubes are interconnected to form a single lamp tube, and are incorporated with a variable voltage system to control the common voltage of the lamp tubes, so that the luminescence efficiencies of the fluorescent powders disposed in the lamp tubes with different diameters are different. Thus, when the common voltage of the lamp tubes changes, the luminescence efficiencies of different fluorescent powder change accordingly, so that the mixed light color of the lamp tubes changes and generates the effect of changing light colors. Compared with the conventional variable color discharge lamp which employs at least three adjusting systems for changing the intensity of the rare-gas discharge lamps of the red/green/blue lights respectively, the variable color discharge lamp disclosed in the above embodiments of the invention has a much simpler structure. Besides, the variable color discharge lamp of the invention only employs a single variable voltage system and the light color is already adjustable by changing the voltage of the power supply. Moreover, the variable color discharge lamp of the invention has a wider range of color adjustment, and is more applicable to market products.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A variable color discharge lamp, comprising:
a first lamp tube having a first diameter, wherein the first lamp tube has a first fluorescent powder disposed therein, and the first fluorescent powder has a first color temperature;
a second lamp tube having a second diameter not equal to the first diameter, wherein the second lamp tube having a second fluorescent powder disposed therein is connected to the first lamp tube, and the second fluorescent powder has a second color temperature not equal to the first color temperature; and
a variable voltage system for providing and adjusting a common voltage of the first lamp tube and the second lamp tube;
wherein when the common voltage is adjusted, respective luminescence efficiencies of the first fluorescent powder and the second fluorescent powder vary with the common voltage, so as to adjust the mixed light color of the first lamp tube and the second lamp tube.

2. The variable color discharge lamp according to claim 1, wherein at least one of the first lamp tube and the second lamp tube is a U-shaped tube.

3. The variable color discharge lamp according to claim 2, further comprising a third lamp tube, which connects the first lamp tube and the second lamp tube, wherein the first lamp tube, the second lamp tube and the third lamp tube are three U-shaped tubes.

4. The variable color discharge lamp according to claim 3, wherein the third lamp tube having a third diameter has a third fluorescent powder disposed therein, the third diameter is not equal to the first diameter or the second diameter, and the third color temperature is not equal to the first color temperature or the second color temperature.

5. The variable color discharge lamp according to claim 1, wherein the first lamp tube is a spiral tube.

6. The variable color discharge lamp according to claim 5, wherein the second lamp tube is a U-shaped tube surrounded by the spiral tube.

7. The variable color discharge lamp according to claim 1, wherein when the first diameter is smaller than the second diameter, under the common voltage, the luminescence efficiency of the first fluorescent powder disposed in the first lamp tube is larger than the luminescence efficiency of the second fluorescent powder disposed in the second lamp tube.

8. The variable color discharge lamp according to claim 1, wherein when the first diameter is smaller than the second diameter, the first color temperature of the first fluorescent powder is larger than the second color temperature of the second fluorescent powder.

9. The variable color discharge lamp according to claim 1, wherein the variable voltage system comprises:
an adjustment unit used for providing a plurality of light color options;
a voltage conversion unit used for converting the common voltage to a predetermined voltage corresponding to a selected light color option of the light color options; and
a voltage output unit used for outputting the predetermined voltage to the first lamp tube and the second lamp tube.

10. The variable color discharge lamp according to claim 1, the lamp is being a compact fluorescent lamp (CFL), a hot cathode fluorescent lamp (HCFL) or a cold cathode fluorescent lamp (CCFL).
